(19) United States
(12) Patent Application Publication
(10) Pub. No.: US 2007/0039654 A1
(43) Pub. Date: Feb. 22, 2007

(54) Spring energized lip seal faucet ball valve

(76) Inventor: Thomas Pinette, Indianapolis, IN (US)

Correspondence Address: CARLSON, GASKEY & OLDS, P.C., 400 WEST MAPLE ROAD, SUITE 350, BIRMINGHAM, MI, 48009, US

(21) Appl. No.: 11/209,100

(22) Filed: Aug. 22, 2005

(51) Int. Cl. F16K 11/076

(52) U.S. Cl. 137/625.41

(57) ABSTRACT

A faucet assembly includes a housing that defines a cavity. Within the cavity there is a ball valve that is held in place by cam surfaces of a cam. The cam surfaces positively and directly contact the ball valve without a pliable seal member disposed there between. The possible location of the ball valve eliminates linear movement. Further, a seal assembly is disposed between the cam and the ball valve in locations that are not in direct contact with the cam surfaces. The cam surfaces hold the ball valve in place separately from the seal resulting in less load on the seal to provide lengthened seal life.

### BACKGROUND OF THE INVENTION

This invention generally relates to a ball valve for a faucet. More particularly this invention relates to mounting of a ball valve assembly within a faucet.

Faucet assemblies are known that include a ball valve for selectively controlling flow from a hot water and a cold-water inlet. The ball valve is typically disposed within a cavity defined by a faucet housing. The ball valve includes a stem that is manipulated to control the mixture of hot and cold water. The stem extends upward through a seal that prevents leakage along the stem of the ball valve. The inlets for the hot and cold water include seals that are biased against the ball valve. The ball valve is supported within the housing by a top seal disposed around the stem, and bottom seals for each of the inlets. Support of the ball valve assembly between the pliable top and bottom seals results in an undesirable spongy feel to the ball valve during operation.

Disadvantageously, the pliable surfaces provided by the seals wear and set over time. Once the seals have set or worn, slight downward pressure can cause undesirable leakage. Further, the spongy feel that is provided by substantially pliable top and bottom seals does not provide a desired positive feel to operation of the faucet assembly.

Accordingly, it is desirable to develop a ball valve assembly that provides a positive feel with improved sealing properties for a desired operational life of the faucet assembly.

### SUMMARY OF THE INVENTION

This invention is a faucet assembly including a ball valve that is held within a cavity by a cam. The cam is in positive and direct contact with the ball valve to provide a rigid and positive location of the ball valve within the cavity.

An example faucet assembly according to this invention includes the housing that defines a cavity. Also defined within the cavity are inlets and outlets that communicate fluid to the cavity for regulation by the ball valve. The ball valve includes a plurality of openings that correspond with the inlets and outlets defined within the cavity. Movement and rotation of the ball valve within the cavity selectively directs fluid flow to the outlet.

The ball valve is held in a positive manner within the cavity by a cam. The cam includes a cam surface that directly abuts the ball valve. The cam provides a rigid placement of the ball valve within the cavity. As appreciated, prior art ball valve assemblies include elastomeric seals that maintain the ball valve within the cavity. The elastomeric seals often would wear resulting in undesirable movement of the ball valve.

The ball valve assembly of this invention includes a positive location within a cavity that is provided by a non-sealing cam surface of the cam. An upper seal is disposed and supported with the cam and is in sealing contact with the ball valve in an area that is not in direct contact with the cam surface. In this way, the ball valve positioning function is separated from the sealing function. The separation of the sealing and location functions provide for the increased durability of the seal.

Accordingly, the faucet assembly of this invention provides a positive feel to the ball valve for the entire operational life of the ball valve without requiring replacement or seal adjustment.

These and other features of the present invention can be best understood from the following specification and drawings, the following of which is a brief description.

### BRIEF DESCRIPTION OF THE DRAWINGS

FIG. 1 is a cross-sectional view of a ball valve assembly according to this invention.

FIG. 2 is another cross-sectional view of an example ball valve assembly according to this invention.

FIG. 3 is an exploded view of the example ball valve assembly according to this invention.

### DETAILED DESCRIPTION OF THE PREFERRED EMBODIMENT

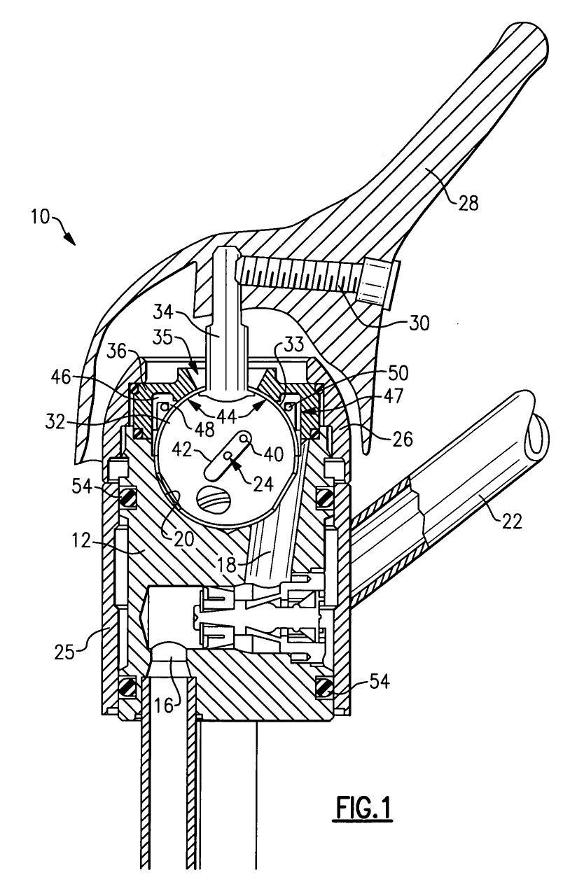

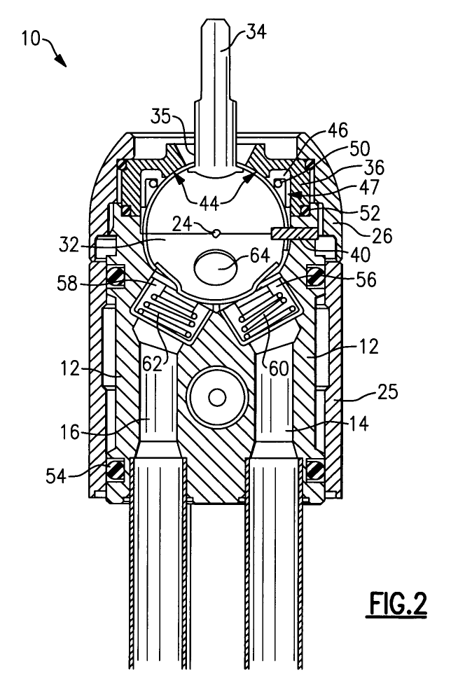

Referring to FIG. 1, the faucet assembly 10 includes a housing 12 that defines a first inlet 14 and a second inlet 16 (Best shown in FIG. 2). The housing 12 also defines an outlet 18 that provides a fluid passage to a spout 22. The housing 12 defines a cavity 20 that is in complete communication with the first and second inlets 14 and 16 and the outlet 18. The cavity 20 supports a ball valve 32 that includes inlet openings and outlet openings that corresponds to the inlets 14, 16 and outlet 18 that are defined within the housing 12. Spherical movement of the ball valve 32 about a point 24 selectively communicates fluid between the inlets 14, 16 and the outlet 18.

The ball valve 32 is held within the cavity 20 by a cam 36. The cam 36 positively locates and holds the ball valve 32 within the cavity 20. The cam 36 is held within the housing 12 by a cap 26. A cover 25 is assembled over the housing 12. O-rings 54 are disposed between the cover 25 and the housing 12. The O-rings 54 provide a desired sealing function and also provide a friction fit that holds the cover 25 onto the housing 12.

The ball valve 32 includes a stem 34 that extends upwards through a cam slot 35 defined by the cam 36. The cam slot 35 is shaped to limit spherical movement of the ball valve 32 within the cavity 20 to communicate selectively with the first and second inlets 16, 14 and the outlet 18. A handle 28 is attached and secured to the stem 34 by way of the fastener 30. Movement of the handle 28 rotates the ball valve 32 within the cavity 20 to provide the desired mix of fluid that will exit through the spout 22.

The ball valve 32 is rotatable about a point 24. The ball valve 32 is held and prevented from moving axially upward in a direction out of the cavity 20 by the cam 36. The cam 36 includes cam surfaces 44 that are in direct abutting contact with a surface 33 of the ball valve 32. This direct abutting contact positively and directly locates the ball valve 32 within the cavity 20 of the housing 12.

The interface between the ball valve 32 and the cam surface 44 provides for positive location of the ball valve 32, however, this positive location does not provide for sealing against leakage of fluid. Accordingly, a seal 46 abuts the surface 33 of the ball valve 32 in a location that is not in contact with the cam surface 44 of the cam 36. In this way, the location function and sealing function are separated. The tolerance stack up for locating the ball valve 32 does not include a pliable member such as a seal and therefore the ball valve 32 is positively located within the cavity without the requirement for an adjustment device.

The seal 46 includes a lip portion 48 that is in direct sealing contact with the surface 33 of the ball valve 32. The seal 46 also includes a cam-sealing surface 47 that abuts an inner surface of the cam 36. The seal 46 therefore provides the sealing function required to prevent fluid flow or leakage around the ball valve 32.

The seal 46 also includes a biasing member 50. The biasing member 50 provides an energization function that biases the lip 48 towards and against the surface 33 of the ball valve 32. The biasing member 50 is a metal ring that is disposed within a cavity between the lip 48 and the cam-sealing surface 47. The biasing member 50 may also be provided and fabricated from other material besides metal, for example plastic.

Referring to FIG. 2, the faucet assembly 10 is shown without the handle 28 for clarity. The faucet 10 is shown here in a side view illustrating the first inlet 14 and the second inlet 16. The first inlet 14 and second inlet 16 communicate water from different water sources as is known for hot and cold faucets. The inlets 14 and 16 terminate at the cavity 20. The inlets communicate fluid to the cavity 20 and include seals 56,58 that seal against the outer surface 33 of the ball valve 32. The inlet seals 58, 56 are biased to contact the surface 33 by biasing members 62, 60. The biasing members 62,60 push against the ball valve 32 to apply a desired sealing pressure on the seals 56 and 58. However, the ball valve 32 does not move due to the biasing member 62, 60 due to the positive location provided by the cam 36. The biasing members 62,60 force the seals 58, 56 against the surface 33 of the ball valve 32.

The ball valve 32 is held within the cavity 20 against sliding surfaces provided by the housing 12 and by the cam 36. The cam 36 includes the cam surfaces 44 that directly contact the ball valve 32 and prevent the ball valve 32 from moving substantially linearly within the cavity 20.

The ball valve 32 includes an outlet opening 64 that communicates with the outlet 18 (FIG. 1) that is not shown in this view. Operation of the ball valve 32 includes spherical movement of the ball valve 32 about the point 24. The spherical movement of the ball valve 32 is limited such that the point 24 does not move linearly in any direction. The absence of linear movement substantially eliminates the need for adjustment and increases the life of seal 36. Further, rotation of the ball valve 32 about the point 24 is limited by a pin member 40 disposed within a slot 42 of the ball valve 32. The pin member 40 limits the amount of spherical movement allowable to maintain a desired alignment of the ball valve 32 with the inlets 14, 16 and the outlet 18.

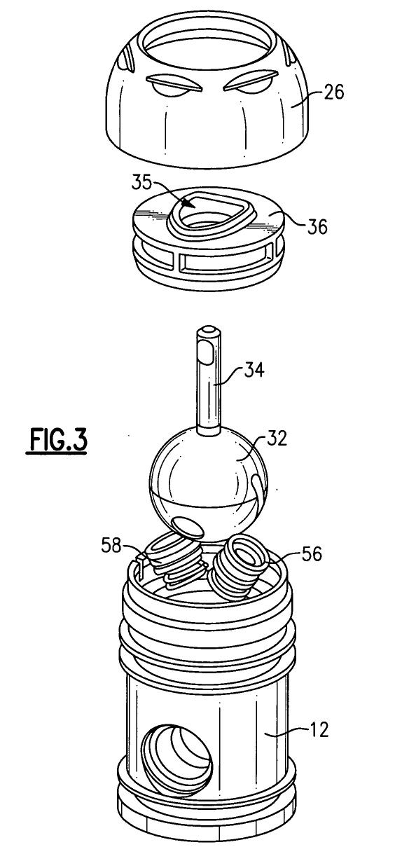

Referring to FIG. 3, the faucet assembly 10 is shown in an exploded view where the ball valve 32 fits within the cavity 20 of the housing 12. The seals 56, 58 abut and seal against the ball valve 32 and the cam 36 provides a positive sealing contact with the ball at the inlets 14, 16. The cam 36 positively contacts the ball valve 32 to provide a positive upper stop against upward movement of the ball valve 32. The cam 36 and ball valve 32 are held within the housing 12 by the cap 26. The direct and positive location of the ball valve 32 utilizing the cam 36 of this invention provides for a separation of the sealing function and the positive location and tolerance stack up function. This separation reduces the wear on the seals 46 (FIGS. 1 and 2) thereby increasing the operational life of the faucet assembly 10 and the seals 46. Further, because the ball valve 32 is positively located by the cam 36, there is a substantial reduction in possible linear movement resulting in a more durable seal.

Accordingly, a faucet assembly according to this invention provides a cam 36 providing a cam surface 44 that directly and positively contacts an outer surface 33 of the ball valve 32. This direct contact positively locates the ball valve 32 such that a pliable member such as seal does not provide for holding the ball valve 32 in place, thereby improving seal durability.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A faucet assembly comprising:
a housing defining a cavity;
a ball valve disposed within said cavity to control water flow between an inlet and an outlet;
a cam abutting directly against said ball valve to maintain said ball valve within said cavity; and
a seal between said cam and a portion of said ball valve that does not abut said cam.

2. The assembly as recited in claim 1, wherein said cam includes a cam surface that abuts directly against said ball valve.

3. The assembly as recited in claim 1, wherein said cam includes a seal surface that contacts said seal.

4. The assembly as recited in claim 1, wherein said cam includes an opening for a stem of said ball valve.

5. The assembly as recited in claim 1, wherein said seal includes a lip portion that seals against a surface of said ball valve.

6. The assembly as recited in claim 5, including a biasing member that biases said lip portion into sealing contact with said ball valve.

7. The assembly as recited in claim 6, wherein said biasing member comprises a ring disposed about an outer circumference of said lip.

8. The assembly as recited in claim 1, including at least one inlet seal disposed between said cavity and said ball valve.

9. The assembly as recited in claim 1, wherein said cam holds said ball valve in a rigid position to allow spherical movement about a point and limit linear movement of the ball valve.

10. The assembly as recited in claim 1, including a cap for holding said cam within said housing.

11. A faucet assembly comprising:
a housing defining a cavity;
a ball valve disposed within said cavity to control water flow between an inlet and an outlet;
a cam for fixing said ball valve within said cavity such that said ball valve is rotatable about an axis and linearly fixed within said cavity; and
a seal between said cam and a portion of said ball valve that does not abut said cam.

12. The assembly as recited in claim 11, wherein said cam includes an opening and said ball valve includes a stem extending through said opening.

13. The assembly as recited in claim 12, including a cam plate having a slot disposed over said opening within said cam, wherein said stem extends upwardly through said slot and said slot limits spherical movement of said ball valve.

14. The assembly as recited in claim 11, including a cap that holds said cam within said housing.
